(19) United States
(12) Patent Application Publication
(10) Pub. No.: US 2014/0143542 A1
(43) Pub. Date: May 22, 2014

(54) Method and Apparatus for Managing Encrypted Folders in Network System

(71) Applicant: Cloudioh Inc., Taipei City (TW)

(72) Inventor: Yan-Cheng Chang, New Taipei City (TW)

(21) Appl. No.: 13/905,145

(22) Filed: May 30, 2013

Related U.S. Application Data
(60) Provisional application No. 61/728,237, filed on Nov. 20, 2012.

(51) Int. Cl. H04L 29/06

(52) U.S. Cl. CPC H04L 63/0435
USPC 713/165

(57) ABSTRACT

A method for managing an encrypted folder in a shared storage in a network system, the method comprising generating a symmetric cryptographic key for a folder; generating a first metadata according to a symmetric encrypting function of the symmetric cryptographic key for the folder operating with a symmetric cryptographic key for a remote folder; and creating the folder with the first metadata in the remote folder; wherein the remote folder has a second metadata or an access control list comprising at least one entry with at least one identity of at least one collaborator, at least one public key of the at least one collaborator and at least one encryption of the symmetric cryptographic key for the remote folder according to an asymmetric encrypting function operating with the at least one public key of the at least one collaborator, for providing the symmetric cryptographic key for the remote folder.

### CROSS REFERENCE TO RELATED APPLICATIONS

This application claims the benefit of U.S. Provisional Application No. 61/728,237, filed on Nov. 20, 2012, entitled “Secure and Efficient Systems for Operations against Encrypted Files”, the contents of which are incorporated herein in their entirety.

### BACKGROUND OF THE INVENTION

1. Field of the Invention

The present invention relates to a method and apparatus utilized in a network system, and more particularly, to a method and apparatus of managing an encrypted folder in a shared storage in a network system.

2. Description of the Prior Art

Nowadays, users often collaborate on computer files in a shared storage provided by an internal corporate information technology department or an external service provider, such as Box, Dropbox or Google Drive. For example, if a file is stored in Google Drive, a collaborator who works on a local copy of the file in a personal computer using certain computer software can update the remote version in Google Drive with his local version. And other collaborators can further access the new version of the file.

For privacy and confidentiality reasons, encrypting the file is desirable before uploading the file to the shared storage. Accordingly, it is necessary to make sure the collaborators have correct access rights to maintain the encrypted file while the secret cryptographic keys are only known to the collaborators.

With respect to encryption, an asymmetric encrypting algorithm uses both public and secret cryptographic keys, such as an RSA algorithm, while a symmetric encrypting algorithm uses secret cryptographic keys only, such as an AES algorithm. In practice, one should take special care of the issue of initialization vector (IV). An IV is a block of bits that is used to randomize the encryption and hence to produce distinct ciphertexts even if the same plaintext is encrypted multiple times, without the need for a slower re-keying process. Most symmetric cryptographic algorithms require anew random IV every time they are used for encryption. And such IVs have to he stored alone with ciphertexts so that decryption is possible.

Therefore, due to the intrinsic complexity of such a system, how to securely share and efficiently manage the secret cryptographic keys becomes an important issue.

### SUMMARY OF THE INVENTION

The present invention therefore provides a method and apparatus for managing an encrypted folder in a shared storage in a network system, to keep the secret cryptographic key used for encrypting files in a folder secure and confidential. In other word, the goal is to protect the secret cryptographic key for decrypting the encrypted files in a folder from unauthorized access, while allowing efficient folder operations.

Without loss of generality we assume in the beginning the root folder for a user in a shared storage in a network system is empty, and a secret cryptographic key associated with the root folder is only known to the user.

A method for managing an encrypted folder in a shared storage in a network system is disclosed. The method comprises generating a symmetric cryptographic key for a folder; generating a first metadata according to a symmetric encrypting function of the symmetric cryptographic key for the folder operating with a symmetric cryptographic key for a remote folder; and creating the folder with the first metadata in the remote folder; wherein the remote folder has a second metadata or an access control list for providing the symmetric cryptographic key for the remote folder and the access control list comprises entries with each comprising an identity of a collaborator, a public key of the collaborator and an encryption of a symmetric cryptographic key for the remote folder according to an asymmetric encrypting function operating with the public key of the collaborator.

A computer readable medium comprising multiple instructions stored in a computer readable device is disclosed. Upon executing these instructions, a computer performs the following steps: generating a symmetric cryptographic key for a folder; generating a first metadata according to the symmetric encrypting function of the symmetric cryptographic key for the folder operating with a symmetric cryptographic key for a remote folder; and creating the folder with the first metadata in the remote folder; wherein the remote folder has a second metadata or an access control list for providing the symmetric cryptographic key for the remote folder and the access control list comprises entries with each comprising an identity of a collaborator, a public key of the collaborator and an encryption of a symmetric cryptographic key for the remote folder according to an asymmetric encrypting function operating with the public key of the collaborator.

A computer apparatus for a network system is disclosed. The computer apparatus comprises a processing means; a storage unit; and a program code, stored in the storage unit, wherein the program code instructs the processing means to execute the following steps: generating a symmetric cryptographic key for a folder; generating a first metadata according to a symmetric encrypting function of the symmetric cryptographic key for the folder operating with a symmetric cryptographic key for a remote folder; and creating the folder with the first metadata in the remote folder; wherein the remote folder has a second metadata or an access control list for providing the symmetric cryptographic key for the remote folder and the access control list comprises at least one entry with at least one identity of at least one collaborator, at least one public key of the at least one collaborator and at least one encryption of the symmetric cryptographic key for the remote folder according to an asymmetric encrypting function operating with the at least one public key of the at least one collaborator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network system according to an example of the present invention.

FIG. 2 is a schematic diagram of a computer apparatus according to an example of the present invention.

FIGS. 3-6 are flowcharts of processes according to examples of the present invention.

### DETAILED DESCRIPTION

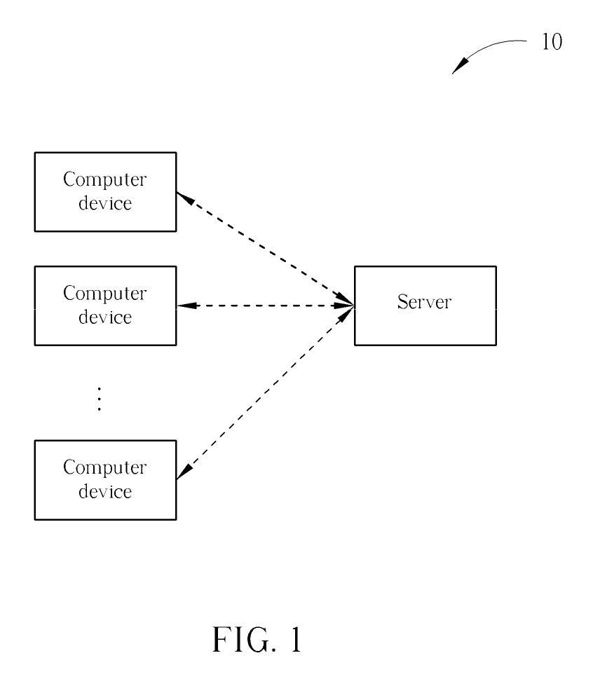

Please refer to FIG. 1, which is a schematic diagram of a network system 10 according to an example of the present invention. The network system 10 is briefly composed of a server and a plurality of computer devices. In FIG. 1, the server and the computer devices are simply utilized for illustrating the structure of the network system 10. Practically, the server can be an internal corporate information technology or an external service provider, such as Box, Dropbox or Google Drive, providing a shared storage. Besides, users can manage the shared storage by remote access in the computer devices.

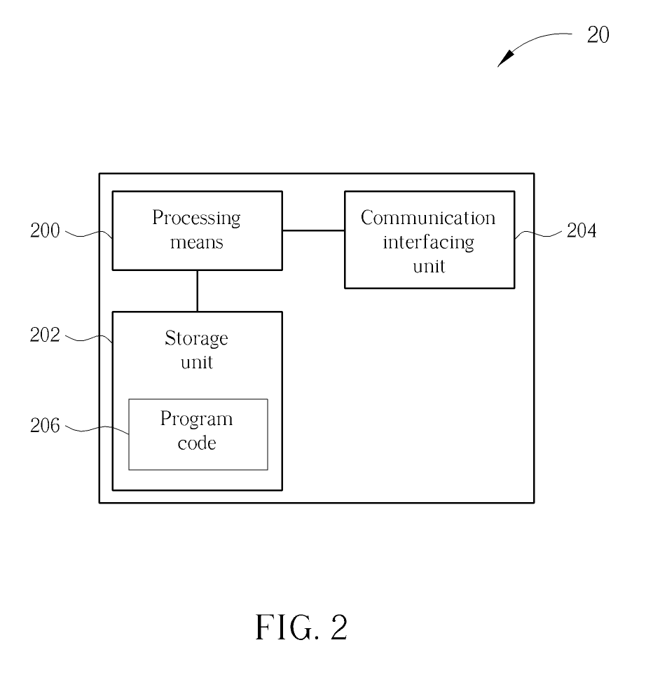

Please refer to FIG. 2, which is a schematic diagram of a computer apparatus 20 according to an example of the present invention. The computer apparatus 20 can be one of the computer devices shown in FIG. 1, but is not limited thereto. The computer apparatus 20 may include a processing means 200 such as a microprocessor or Application Specific Integrated Circuit (ASIC), a storage unit 202 and a communication interfacing unit 204. The storage unit 202 may be any data storage device that can store a program code 206, accessed and executed by the processing means 200. Examples of the storage unit 202 include but are not limited to read-only memory (ROM), flash memory, random-access memory (RAM), CD-ROM/DVD-ROM, magnetic tape, hard disk and optical data storage device. The communication interfacing unit 204 is preferably a transceiver and is used to transmit and receive signals (e.g., messages or packets) according to processing results of the processing means 200.

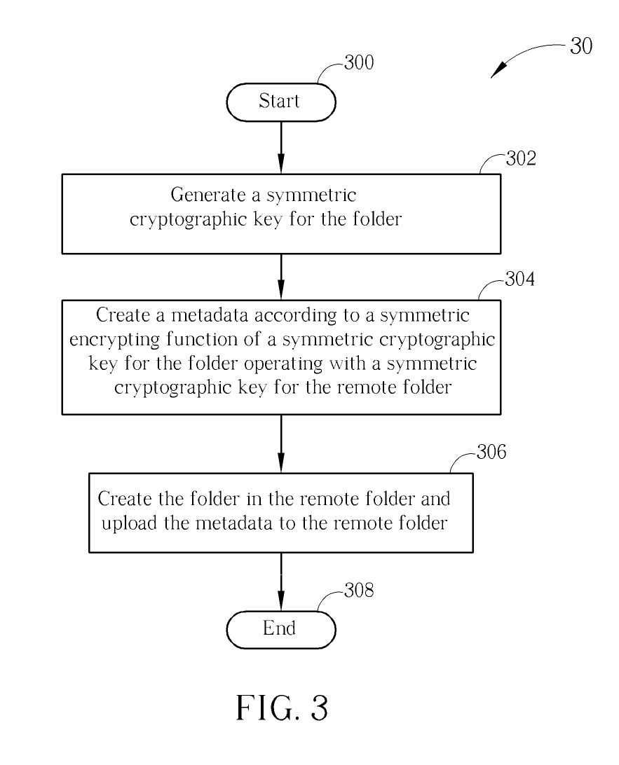

Please refer to FIG. 3, which is a flowchart of a process 30 according to an example of the present invention. The process 30 is utilized in the network system 10 shown in FIG. 1, for securely managing a folder in a remote folder in the shared storage by one of the computer devices. The process 30 can be implemented in the computer apparatus 20 and may be compiled into the program code 206. The process 30 includes the following steps:

Step 300: Start.

Step 302: Generate a symmetric cryptographic key for the folder.

Step 304: Create a metadata according to a symmetric encrypting function of a symmetric cryptographic key for the folder operating with a symmetric cryptographic key for the remote folder.

Step 306: Create the folder in the remote folder and upload the metadata to the remote folder.

Step 308: End.

According to the process 30, the symmetric cryptographic key for the folder is generated and encrypted to create the metadata and the metadata is further uploaded to the remote folder. Therefore, the folder in the remote folder can be created and managed securely by the metadata.

Moreover, a folder can further be moved from the remote folder into another target folder. In detail, the metadata is first downloaded from the remote folder, and the symmetric cryptographic key for the folder is obtained according to the symmetric decrypting function of the metadata operating with the symmetric cryptographic key for the remote folder. Next, the new metadata is generated according to the symmetric encrypting function of the symmetric cryptographic key for the folder operating with the symmetric cryptographic key for the target folder. And after the new metadata is uploaded to the target folder, the folder can be moved from the remote folder to the target folder to complete the moving operation. Note this moving operation is executable only for those who have access to both the symmetric cryptographic key for the remote folder and the symmetric cryptographic key for the target folder.

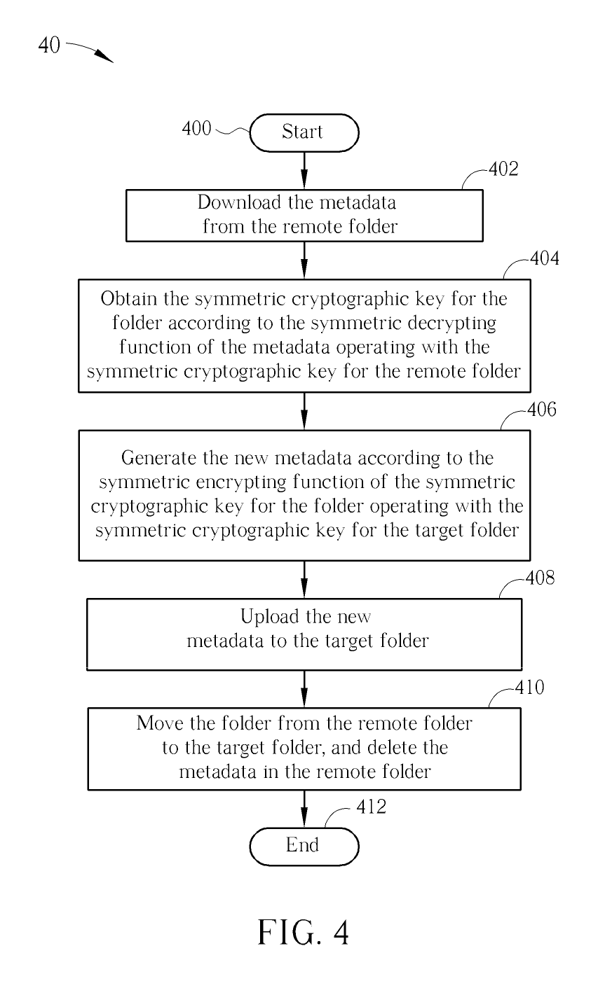

As seen from the above, the moving operation can be summarized to processes 40, as shown in FIG. 4. The processes 40 can be implemented in the computer apparatus 20 and may be compiled into the program code 206. The process 40 includes the following steps:

Step 400: Start.

Step 402: Download the metadata from the remote folder.

Step 404: Obtain the symmetric cryptographic key for the folder according to the symmetric decrypting function of the metadata operating with the symmetric cryptographic key for the remote folder.

Step 406: Generate the new metadata according to the symmetric encrypting function of the symmetric cryptographic key for the folder operating with the symmetric cryptographic key for the target folder.

Step 408: Upload the new metadata to the target folder.

Step 410: Move the folder from the remote folder to the target folder, and delete the metadata in the remote folder.

Step 412: End.

Note that, the processes 30 and 40 are examples of the present invention, and those skilled in the art should readily make combinations, modifications and/or alterations on the above-mentioned description and examples. The symmetric encrypting function may be an AES algorithm, but not limited thereto. In the process 30, the folder can later be viewed as a remote folder so that another folder can be created within. In other words, process 30 can be executed recursively, and the accessibility of a parent folder implies the accessibility of all its child folders.

In another aspect, when some encrypting algorithms requiring initialization vectors (IV) are employed, one has to update and record the corresponding IV (which is used along with the remote folder key to encrypt a folder key) whenever encryption is executed. This is because the same remote folder key is used to encrypt all the folder keys within the remote folder. In other words, each folder needs a unique IV, and the IV is suggested to be stored in the metadata for a folder.

In addition, the symmetric cryptographic key for the folder is encrypted by the computer device before being uploaded. Therefore, the symmetric cryptographic key for the folder is only accessible to those who have access to the symmetric cryptographic key for the remote folder, hence it is secured. Also note this operation is executable only for those who have access to the symmetric cryptographic key for the remote folder. For example, the symmetric cryptographic key for the remote folder may be encrypted and managed in another metadata generated for the remote folder or an access control list to permit some specific collaborators to access the remote folder. The symmetric cryptographic key for the remote folder may also be directly known by the collaborators in any way.

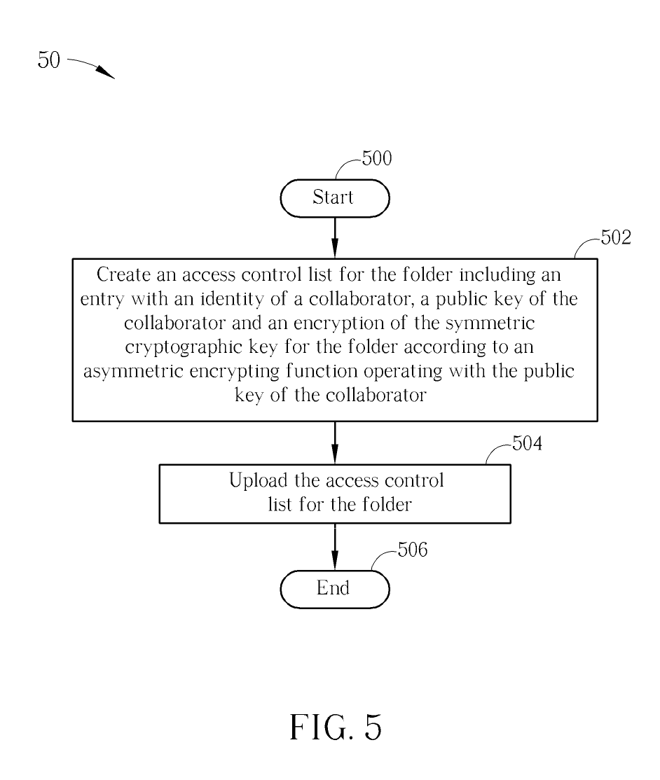

Please refer to FIG. 5, which is a flowchart of a process 50 according to an example of the present invention. The process 50 is utilized in the network system 10 shown in FIG. 1, for creating an access control list for a folder in the shared storage by one of the computer devices, to allow a collaborator and no one else to access the folder. The process 50 can be implemented in the computer apparatus 20 and may be compiled into the program code 206. The process 50 includes the following steps:

Step 500: Start.

Step 502: Create an access control list for the folder including an entry with an identity of a collaborator, a public key of the collaborator and an encryption of the symmetric cryptographic key for the folder according to an asymmetric encrypting function operating with the public key of the collaborator.

Step 504: Upload the access control list for the folder.

Step 506: End.

According to the process 50, the symmetric cryptographic key for the folder is encrypted by the computer device operating with the public key of the collaborator before being adding to the access control list. Therefore, the symmetric cryptographic key for the folder is only accessible to the collaborator who owns the corresponding private key for decryption. Also note this operation is executable only for those who have access to the symmetric cryptographic key for the folder.

Moreover, the access control list may be updated, that is, new collaborators can be added while existing collaborators can be removed. In detail, the access control list is first downloaded, and the encryption of the symmetric cryptographic key for the folder that matches the identity of the downloader in the access control list is identified so that the symmetric key for the folder can be obtained according to the asymmetric decrypting function of the identified encryption operating with the private key of the downloader. Next, for the adding operation, an entry with the identity of a collaborator, a public key of the collaborator and an encryption of the symmetric cryptographic key for the folder according to an asymmetric encrypting function operating with the public key of the collaborator is added into the access control list. And for the removing operation, the entry with the identity of a collaborator, the public key of the collaborator and the encryption of the symmetric cryptographic key for the remote folder according to the asymmetric encrypting function operating with the public key of the collaborator is removed from the access control list. In any case, the new access control list for the folder is uploaded to replace the old access control list for the folder.

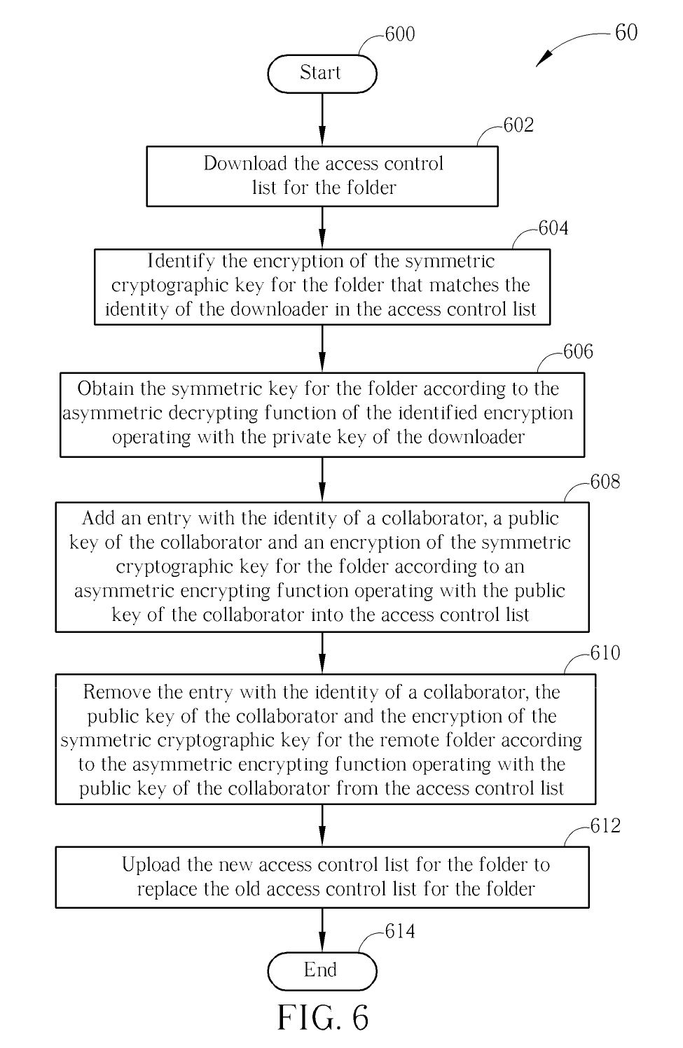

As seen from the above, the updating operation can be summarized to processes 60, as shown in FIG. 6. The processes 60 can be implemented in the computer apparatus 20 and may be compiled into the program code 206. The process 60 includes the following steps:

Step 600: Start.

Step 602: Download the access control list for the folder.

Step 604: Identify the encryption of the symmetric cryptographic key for the folder that matches the identity of the downloader in the access control list.

Step 606: Obtain the symmetric key for the folder according to the asymmetric decrypting function of the identified encryption operating with the private key of the downloader.

Step 608: Add an entry with the identity of a collaborator, a public key of the collaborator and an encryption of the symmetric cryptographic key for the folder according to an asymmetric encrypting function operating with the public key of the collaborator into the access control list.

Step 610: Remove the entry with the identity of a collaborator, the public key of the collaborator and the encryption of the symmetric cryptographic key for the remote folder according to the asymmetric encrypting function operating with the public key of the collaborator from the access control list.

Step 612: Upload the new access control list for the folder to replace the old access control list for the folder.

Step 614: End.

Note that, the processes 50 and 60 are examples of the present invention, and those skilled in the art should readily make combinations, modifications and/or alterations on the above-mentioned description and examples. The asymmetric encrypting function may be a RSA algorithm, but not limited thereto. In process 60, the downloading and decrypting steps are not necessary for those who already have access to the symmetric cryptographic key for the folder.

In another aspect, the folder may be a parent folder or a child folder of the parent folder, such as the remote folder or the folder in the processes 30 and 40, but not limited herein.

In the present invention, the computer device creates and moves folders in remote folders while keeping the symmetric cryptographic key for the folders secure. Also the computer device creates and updates the access control list for folders to only allow authorized collaborators to access the folders.

To sum up, the present invention provides a method and apparatus for managing an encrypted folder in a shared storage in a network system, to keep the secret cryptographic key used for encrypting files in a folder secure and confidential.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing an encrypted folder in a shared storage in a network system, the method comprising:
generating a symmetric cryptographic key for a folder;
generating a first metadata according to a symmetric encrypting function of the symmetric cryptographic key for the folder operating with a symmetric cryptographic key for a remote folder; and
creating the folder with the first metadata in the remote folder;
wherein the remote folder has a second metadata or an access control list for providing the symmetric cryptographic key for the remote folder and the access control list comprises at least one entry with at least one identity of at least one collaborator, at least one public key of the at least one collaborator and at least one encryption of the symmetric cryptographic key for the remote folder according to an asymmetric encrypting function operating with the at least one public key of the at least one collaborator.

2. The method of claim 1, wherein the symmetric cryptographic key for the remote folder is obtained according to a symmetric decrypting function of the second metadata for the remote folder operating with a symmetric cryptographic key for a parent folder of the remote folder or obtained according to an asymmetric decrypting function of an encryption operating with a private key of a collaborator and the encryption is obtained from the access control list.

3. The method of claim 1, the method further comprises:
downloading the metadata from the remote folder;
obtaining the symmetric cryptographic key for the folder according to a symmetric decrypting function of the metadata operating with the symmetric cryptographic key for the remote folder;
generating a new metadata according to the symmetric encrypting function of the symmetric cryptographic key for the folder operating with the symmetric cryptographic key for a target folder;
uploading the new metadata to the target folder;
moving the folder from the remote folder to the target folder; and
deleting the metadata in the remote folder.

4. The method of claim 1, wherein the method further comprises:
downloading the access control list;
identifying an encryption of the symmetric cryptographic key for the remote folder that matches an identity of a downloader in the access control list;
obtaining the symmetric cryptographic key for the remote folder according to an asymmetric decrypting function of the identified encryption operating with a private key of the downloader;
updating the access control list; and
uploading the access control list to the remote folder.

5. The method of claim 4, wherein updating the access control list comprises adding an entry with an identity of a collaborator, a public key of the collaborator and an encryption of the symmetric cryptographic key for the remote folder according to the asymmetric encrypting function operating with the public key of the collaborator into the access control list.

6. The method of claim 4, wherein updating the access control list comprises removing an entry with an identity of a collaborator, a public key of the collaborator and an encryption of the symmetric cryptographic key for the remote folder according to the asymmetric encrypting function operating with the public key of the collaborator from the access control list wherein the collaborator is one of the at least one collaborators.

7. A computer readable medium comprising multiple instructions stored in a computer readable device, upon executing these instructions, a computer performing the following steps:
generating a symmetric cryptographic key for a folder;
generating a first metadata according to a symmetric encrypting function of the symmetric cryptographic key for the folder operating with a symmetric cryptographic key for a remote folder; and
creating the folder with the first metadata in the remote folder;
wherein the remote folder has a second metadata or an access control list for providing the symmetric cryptographic key for the remote folder and the access control list comprises at least one entry with at least one identity of at least one collaborator, at least one public key of the at least one collaborator and at least one encryption of the symmetric cryptographic key for the remote folder according to an asymmetric encrypting function operating with the at least one public key of the at least one collaborator.

8. The computer readable medium of claim 7, wherein the symmetric cryptographic key for the remote folder is obtained according to a symmetric decrypting function of the second metadata for the remote folder operating with a symmetric cryptographic key for a parent folder of the remote folder or obtained according to an asymmetric decrypting function of an encryption operating with a private key of a collaborator and the encryption is obtained from the access control list.

9. The computer readable medium of claim 7, the steps further comprise:
downloading the metadata from the remote folder;
obtaining the symmetric cryptographic key for the folder according to a symmetric decrypting function of the metadata operating with the symmetric cryptographic key for the remote folder;
generating a new metadata according to the symmetric encrypting function of the symmetric cryptographic key for the folder operating with the symmetric cryptographic key for a target folder;
uploading the new metadata to the target folder;
moving the folder from the remote folder to the target folder; and
deleting the metadata in the remote folder.

10. The computer readable medium of claim 7, wherein the steps further comprise:
downloading the access control list;
identifying an encryption of the symmetric cryptographic key for the remote folder that matches an identity of a downloader in the access control list;
obtaining the symmetric cryptographic key for the remote folder according to an asymmetric decrypting function of the identified encryption operating with a private key of the downloader;
updating the access control list; and
uploading the access control list to the remote folder.

11. The computer readable medium of claim 10, wherein updating the access control list comprises adding an entry with an identity of a collaborator, a public key of the collaborator and an encryption of the symmetric cryptographic key for the remote folder according to the asymmetric encrypting function operating with the public key of the collaborator into the access control list.

12. The computer readable medium of claim 10, wherein updating the access control list comprises removing an entry with an identity of a collaborator, a public key of the collaborator and an encryption of the symmetric cryptographic key for the remote folder according to the asymmetric encrypting function operating with the public key of the collaborator from the access control list wherein the collaborator is one of the at least one collaborators.

13. A computer apparatus for a network system, comprising:
a processing means;
a storage unit; and
a program code, stored in the storage unit, wherein the program code instructs the processing means to execute the following steps:
generating a symmetric cryptographic key for a folder;
generating a first metadata according to a symmetric encrypting function of the symmetric cryptographic key for the folder operating with a symmetric cryptographic key for a remote folder; and
creating the folder with the first metadata in the remote folder;
wherein the remote folder has a second metadata or an access control list for providing the symmetric cryptographic key for the remote folder and the access control list comprises at least one entry with at least one identity of at least one collaborator, at least one public key of the at least one collaborator and at least one encryption of the symmetric cryptographic key for the remote folder according to an asymmetric encrypting function operating with the at least one public key of the at least one collaborator.

14. The computer apparatus of claim 13, wherein the symmetric cryptographic key for the remote folder is obtained according to a symmetric decrypting function of the second metadata for the remote folder operating with a symmetric cryptographic key for a parent folder of the remote folder or obtained according to an asymmetric decrypting function of an encryption operating with a private key of a collaborator and the encryption is obtained from the access control list.

15. The computer apparatus of claim 13, wherein the program code further instructs the processing means to execute:
downloading the metadata from the remote folder;
obtaining the symmetric cryptographic key for the folder according to a symmetric decrypting function of the metadata operating with the symmetric cryptographic key for the remote folder;
generating a new metadata according to the symmetric encrypting function of the symmetric cryptographic key for the folder operating with the symmetric cryptographic key for a target folder;
uploading the new metadata to the target folder;
moving the folder from the remote folder to the target folder; and
deleting the metadata in the remote folder.

16. The computer apparatus of claim 13, wherein the program code further instructs the processing means to execute:
downloading the access control list;
identifying an encryption of the symmetric cryptographic key for the remote folder that matches an identity of a downloader in the access control list;
obtaining the symmetric cryptographic key for the remote folder according to an asymmetric decrypting function of the identified encryption operating with a private key of the downloader;
updating the access control list; and
uploading the access control list to the remote folder.

17. The computer apparatus of claim 16, wherein the step of updating the access control list comprises adding an entry with an identity of a collaborator, a public key of the collaborator and an encryption of the symmetric cryptographic key for the remote folder according to the asymmetric encrypting function operating with the public key of the collaborator into the access control list.

18. The computer apparatus of claim 16, wherein the step of updating the access control list comprises removing an entry with an identity of a collaborator, a public key of the collaborator and an encryption of the symmetric cryptographic key for the remote folder according to the asymmetric encrypting function operating with the public key of the collaborator from the access control list wherein the collaborator is one of the at least one collaborators.
